(19) United States
(12) Patent Application Publication
(10) Pub. No.: US 2026/0357116 A1
(43) Pub. Date: Nov. 12, 2026

(54) LOW-TEMPERATURE HEAT-ACTIVATED FOAMABLE SEALANT MATERIAL

(71) Applicant: Zephyros, Inc., Romeo, MI (US)

(72) Inventors: Chris Hable, Romeo, MI (US); Michael Czaplicki, Romeo, MI (US); Jeff Apfel, Romeo, MI (US); Kevin Mayne, Romeo, MI (US)

(21) Appl. No.: 19/487,175

(22) PCT Filed: May 31, 2024
(86) PCT No.: PCT/US2024/031873

§ 371 Date: Nov. 24, 2025

Related U.S. Application Data
(60) Provisional application No. 63/470,049, filed on May 31, 2023.

(51) Int. Cl. C09K 3/10; C08J 9/10

(52) U.S. Cl. CPC C09K 3/10; C08J 9/103; C08J 2323/08; C08J 2423/08; C08J 2423/22; C08J 2423/28; C08J 2445/02; C08J 2491/02

(57) ABSTRACT

A foamable sealant material comprising one or more polymeric materials, azodicarbonamide as a foaming agent, a water insoluble urea or guanidine derivative, and optionally a zinc carboxylate salt. The water insoluble urea or guanidine derivative and the zinc carboxylate salt cooperate to reduce the activation temperature of the azodicarbonamide.

### CROSS-REFERENCE TO RELATED APPLICATION

The present application claims priority to U.S. Provisional Application No. 63/470,049, which is incorporated herein by reference in its entirety for all purposes.

### FIELD

The present teachings relate to a low-temperature or reduced-temperature heat-activated foamable sealant material, that retains long-term latency when stored at room temperature.

### BACKGROUND

The automotive industry is concerned with the sealing of vehicle interiors from noise, rain, snow, dust, humidity, fuel fumes, and the like for the purposes of passenger comfort, protection of electronics, and corrosion prevention. Among the sealing strategies employed by the automotive industries is the use of heat-activated foamable sealants that may be cross-linkable upon heat activation. These sealants, whether supplied as preformed solids, pressure sensitive strips, flowable liquids, or pumpable pastes, utilize existing ovens in the automotive assembly plants and are activated during one or more of the processing steps used to cure the various layers of coatings (e.g., e-coat, paint, etc.) applied to a vehicle.

Heat-activated sealant materials are conventionally applied early in the vehicle assembly process, in a stage commonly referred to as body-in-white. Body-in-white refers to frame and sheet metal components that are welded, riveted, bolted, or otherwise fastened together. Body-in-white provides access to the tunnels, cavities, seams, and other spaces that require sealing.

After the body-in-white is assembled, an electrophoretic coating (“e-coat”) is typically applied thereto and cured in an oven. It is desirable to match the cross-linking and foaming activation temperatures of heat-activated sealant materials to the curing temperature of the e-coat system. Typically, the curing times and temperatures for existing e-coat systems require the substrate on which the coating is applied to reach a temperature of at least 160 °C for at least 15 minutes, although it can reach 200 °C or more for 40 minutes or more.

Recent efforts in the area of e-coat curing have led to the development of e-coat systems that cure at temperatures as low as 140 °C. Examples of such systems include ENVIRO-Prime® Epic, commercially available from PPG Industries Inc., and CathoGuard®, commercially available from BASF. Curing at lower temperatures relative to conventional e-coat systems allows for significant energy savings. Moreover, higher through-put of body-in-white units may be realized by allowing the same to pass more quickly through the ovens relative to conventional e-coat systems. In this regard, the body-in-white typically does not reach the actual temperature of the oven because of the mass of the metal to be heated and portions of the metal being shielded by other structures. Low temperature e-coat curing is beneficial in the manufacture of electric vehicles as battery compartments are typically constructed of a large mass of metal that can act as a heat sink and shield other areas of the vehicle from oven heat, thus those other areas may not achieve the oven temperature during typical cycle times.

It is typically preferrable to apply or insert sealant materials in the body-in-white stage of assembly. However, it is often necessary to seal an area at a later stage of assembly, e.g., in the paint portion of the assembly operation. Paint shop ovens are often operated at lower temperatures than e-coat ovens, sometimes as low as 120 °C.

Past efforts to achieve low activation temperature in foamable sealant materials have utilized foaming agents with intrinsically lower activation temperatures such as p,p′-oxybis(benzenesulfonyl hydrazide) (“OBSH”) or p-toluenesulfonyl hydrazide (“TSH”). However, these foaming agents are considered to have greater health risk, have a greater cost, are typically available from fewer suppliers, and provide lower gas evolution per unit weight upon decomposition, relative to foaming agents that activate at higher temperatures (e.g., azodicarbonamide, N,N′-dinitrosopentamethylenetetramine, and 5-phenyltetrazole (“5 PT”)). In regard to gas evolution, challenges are realized with OBSH, TSH, and the like in formulating sealant materials that can volumetrically expand by 1,000% or more, 1,500% or more, or even 2,000% or more. Additionally, for applications requiring activation temperatures of 140 °C or less, OBSH, TSH, and the like require further activation with additives such as urea or substituted ureas.

Endothermic foaming agents such as sodium or potassium bicarbonates can offer activation temperatures of 150 °C or less. However, these foaming agents also provide lower gas evolution per unit weight. Thus, challenges are realized with endothermic foaming agents in formulating sealant materials that can volumetrically expand by 1,000% or more, 1,500% or more, or even 2,000% or more due to the amount necessary to achieve these volumetric percentage increases. Endothermic foaming agents also present challenges with regard to moisture sensitivity because they are typically salts with significant water solubility and tend to absorb atmospheric moisture. Moisture absorption interferes with the foaming process, with the absorbed water acting as a blowing agent itself, that is activated at relatively low temperatures, often creating large open-cell structures and/or cellular collapse.

Azodicarbonamide (“ADCA”) is a preferred heat-activated foaming agent for many applications, including the foaming of baked goods as well as the foaming of polymeric materials employed for cushioning and sealing. ADCA is generally considered to have a low health hazard rating, low cost, greater availability, and high gas evolution per unit weight, relative to the aforementioned foaming agents. One potential limitation with ADCA is its high activation or decomposition temperature. Un-activated ADCA is reported to have a decomposition temperature as high as 200-210 °C. The activation temperature of ADCA can be reduced to temperatures that allow for its use in a wide range of applications. Many compounds are known decomposition activators for ADCA, either alone or in combination with other activators. For example, the addition of small quantities (e.g., about 1-2% by weight) of zinc oxide can enable the activation of ADCA at 160 °C or lower. Urea and substituted ureas are also known activators of ADCA decomposition and, in small quantities (e.g., about 1% by weight or less), can reduce the activation temperature of ADCA to 160 °C or lower. Urea and most substituted ureas are effective activators, but highly water soluble and are therefore sensitive to humid environments, resulting in complications from absorbed water described above.

There are limitations with lowering the activation temperature of ADCA by the means discussed above. For example, when lowering the activation temperature of ADCA with zinc oxide, zinc oxide content of about 1% to 2% by weight has a significant effect in lowering the activation temperature, but zinc oxide content above about 2% by weight has a minimal effect on lowering the activation temperature further.

Small quantities of ureas can lower the activation temperature of ADCA to more practical working levels with minimal effect on other properties of the foamable sealant material. Urea quantities as high as 1%, 2%, or even more (by weight) have been used to lower the activation temperature to 140 °C or lower (see, e.g., U.S. Pat. No. 11,192,995 B2, incorporated herein by reference in its entirety for all purposes). However, because of the high water solubility of urea and even some substituted ureas, materials containing urea at quantities of 2% or more, by weight, are prone to water absorption prior to heat activation in an amount that can adversely affect the properties of the foamable sealant material (e.g., foaming prior to cross-linking resulting in reduced final volumetric expansion and poor cell structure). These adverse effects can occur when the material is exposed to high relative humidity for even short periods of time (e.g., 4 days or less, 3 days or less, or even 2 days or less). In addition, urea tends to impart an amine-like odor into the material upon curing.

Other means have been used to reduce the activation temperature of ADCA, such as zinc complexes in combination with amines, amides, and ureas, which have been reported to lower the activation of ADCA to 160 °C or even lower. For example, JP 1980133433 A, incorporated herein by reference in its entirety for all purposes, provides a reaction product of a zinc compound and an amine. Similarly, zinc dicyanatodiamine has been reported as an effective activator of ADCA (see, Rubber World, Aug. 1, 1993, incorporated herein by reference in its entirety for all purposes) when used in combination with zinc oxide. However, zinc dicyanatodiamine as well as other zinc amine complexes carry significant health hazards, and many are also prone to moisture sensitivity.

Some have employed a combination of heavy metal compounds, including compounds or salts of zinc, alone or in combination with other compounds to reduce the activation temperature of ADCA to 160 °C or even lower. Particularly prevalent solutions include zinc compounds together with nitrogen-containing compounds such as amines, amides, and ureas. U.S. Pat. No. 3,305,496 A, incorporated herein by reference in its entirety for all purposes, provides that heavy metal salts with a monovalent alkali metal can reduce the activation temperature of finely divided ADCA to as low as 130 °C to 140 °C. However, a fatty acid amine or amide is included as a dispersing agent in the foaming agent composition to promote solubility into the plastic composition. U.S. Pat. No. 3,321,413 A, incorporated herein by reference in its entirety for all purposes, similarly shows a composition including a heavy polyvalent metal salt, including zinc salts, an alkali metal salt, and an aliphatic hydroxy amine.

U.S. Pat. Nos. 4,554,294 A and 4,634,721 A, incorporated herein by reference in their entirety for all purposes, provide that the zinc salt of nitro-urea, or a combination of zinc oxide and nitro-urea can be used to activate ADCA.

U.S. Pat. No. 4,655,962 A, incorporated herein by reference in its entirety for all purposes, provides that ADCA can be activated at low temperatures with a combination of zinc oxide or zinc carbonate, zinc salts of C1-C6 organic acids, and C1-C6 zinc carboxamides.

The combinations of heavy metal compounds, alkali salts, and amines or other nitrogen-containing compounds cited above presents some challenges. Some of the compounds are associated with high toxicity, most notably compounds of cadmium and lead. The incorporation of alkali metal salts is likely to increase the moisture absorption of the system to be foamed. Additionally, when the foamable material comes into contact with an unpainted metal surface (e.g., for sealing a cavity or reinforcing a metal panel), the presence of an alkali metal salt is likely to be detrimental to the corrosion resistance of the metal.

Many nitrogen-containing compounds are prone to cause moisture absorption, notably hydroxylated amines as well as urea and its derivatives. The presence of some nitrogen-containing compounds limits the types of reactive groups that can be incorporated in a foamable system because of the tendency of those functional groups to react with the nitrogen-containing compound or to be otherwise induced to react in the presence of the nitrogen-containing compound. For example, primary amines will react, through Michael addition, with acrylic monomers that are often incorporated as a coagent for peroxide crosslinking of rubber or plastic foamed materials. Nitrogen-containing compounds such as amines, ureas, and imidazoles may induce the reaction of epoxy functional compounds that are often incorporated into a foamable polymeric system to increase strength or stiffness or to promote adhesion to metallic substrates.

It may be desirable to provide a sealant material that is heat-activated to foam and/or cross-link.

It may be desirable to provide a sealant material that foams and/or cross-links at temperatures of about 160 °C or less, more preferably about 140 °C or less, or even more preferably about 120 °C or less.

It may be desirable to provide a sealant material that employs a foaming agent with a modifiable activation temperature.

It may be desirable to provide a sealant material that foams and/or cross-links, within 20 minutes or less, 15 minutes or less, or even 10 minutes or less, after the metal substrate on which the material is disposed reaches a target temperature (e.g., the temperature of an oven).

It may be desirable to provide a sealant material that foams and/or cross-links in an e-coat oven and/or an oven to which the material is exposed at later stages of vehicle assembly (e.g., a paint oven).

It may be desirable to provide a sealant material that employs a foaming agent that has relatively low health risk; has relatively low cost; is readily available in the market; has a gas evolution that can provide for about 1,000% or more, about 1,500% or more, or even about 2,000% or more, of volumetric expansion; is relatively less sensitive to moisture; or any combination thereof (relative to conventional foaming agents discussed above).

It may be desirable to provide a sealant material that employs an activator that has low moisture sensitivity, presents relatively low health risk, does not negatively affect the corrosion resistance of substrate metals, does not react with and/or promote reaction of functional groups present on typical ingredients at normal processing temperatures of foamable materials, does not require a dispersing agent, or any combination thereof.

### SUMMARY

The present disclosure provides for a foamable sealant material that may address at least some of the desires identified above. The foamable sealant material may comprise one or more polymeric materials, azodicarbonamide as a foaming agent, a water insoluble urea or guanidine derivative, and optionally a zinc carboxylate salt. The water insoluble urea or guanidine derivative and the zinc carboxylate salt cooperate to reduce the activation temperature of the azodicarbonamide. Although the present teachings contemplate that water insoluble urea or guanidine derivative may be present without a zinc carboxylate salt, preferably the foamable sealant material may comprise a water insoluble urea or guanidine derivative and a zinc carboxylate salt.

The activation temperature of azodicarbonamide may be reduced to about 160 °C or less, more preferably about 140 °C or less, or even more preferably 120 °C or less.

The water insoluble urea or guanidine derivative may be dicyandiamide.

The zinc carboxylate salt may be a polymeric zinc ionomer.

The zinc carboxylate salt may be based on a carboxylic acid with 8 or more carbon atoms.

The zinc carboxylate salt may be selected from one or more zinc salts of a long chain carboxylic acids, zinc stearate, zinc laurate, zinc caprylate, zinc neodecanoate, zinc 2-ethylhexanoate, and zinc octoate, or any combination thereof.

The zinc carboxylate salt may be the one or more zinc salts of the long chain carboxylic acids.

The long chain carboxylic acids may have a carbon chain length of C6 to C18.

The long chain carboxylic acids may comprise a mixture of saturated and unsaturated carboxylic acids.

The one or more polymeric materials may include one or more elastomers, thermoplastic elastomers, thermoplastic polymers, polyolefin plastomers, polyolefin elastomers, or any combination thereof.

The one or more elastomers may include ethylene propylene rubber, ethylene propylene diene monomer rubber, styrene butadiene rubber, nitrile rubber, polybutadiene rubber, natural rubber, isobutylene-isoprene rubber, or any combination thereof.

The one or more thermoplastic elastomers may include one or more block copolymers of styrene with butadiene or isoprene (e.g., styrene-butadiene-styrene, styrene-isoprene-styrene, styrene-ethylene-propylene-styrene, styrene-ethylene-butylene-styrene, or any combination thereof).

The one or more polymeric materials may comprise a copolymer and/or a terpolymer of ethylene.

The one or more polymeric materials may include ethylene, polyethylene (e.g., low-density polyethylene and/or linear low-density polyethylene), ethylene octene, ethylene hexene, ethylene butene, n-butyl acrylate copolymer, ethylene vinyl acetate copolymer, ethylene n-butyl acrylate GMA terpolymer, or any combination thereof.

The foamable sealant material may further comprise a thermally conductive filler.

The thermally conductive filler may include iron powder, aluminum powder, zinc powder, aluminum nitride, aluminum oxide (“alumina”), zinc oxide, graphite, graphene, iron phosphide, strontium ferrite, graphitic boron nitride, silicon carbide, or any combination thereof.

The thermally conductive filler may be present in an amount of about 5% to 30% of the foamable sealant material, by weight.

The water insoluble urea or guanidine derivative may be present in an amount of about 0.5% to about 5% of the foamable sealant material, by weight.

The zinc carboxylate salt may be present in an amount of about 0.5% to about 5% of the foamable sealant material, by weight.

The azodicarbonamide may be present in an amount of about 2% to about 15% of the foamable sealant material, by weight.

The azodicarbonamide may have a particle size distribution of about 1 micron to about 20 microns, as determined by ASTM UOP856-07.

The foamable sealant material may be heat-activated to foam and/or cross-link.

A volume of the foamable sealant material may increase by about 150% or more, 300% or more, 500% or more, 800% or more, 1,000% or more, 1,200% or more, or even 1,400% or more. A volume of the foamable sealant material may increase by about 2,200% or less, 2,000% or less, 1,800% or less, or even 1,600% or less.

The foamable sealant material may fully foam and/or cross-link at about 25 minutes or less, or even more preferably about 20 minutes or less.

The volume of the foamable sealant material may increase 1800% or more when heated to 140 °C for 25 minutes.

The foamable sealant material may be free of a dispersing agent.

The one or more polymeric materials may be present in an amount of about 40% to about 70% of the foamable sealant material, by weight.

The foamable sealant material may further comprise an antioxidant. The antioxidant may be present with the thermally conductive filler.

The antioxidant may be derived from sterically hindered phenols.

The antioxidant may be present in an amount of about 0.1% to 2.5% of the foamable sealant material, by weight.

The foamable sealant material may further comprise zinc oxide to reduce the activation temperature of azodicarbonamide.

The zinc oxide may be present in an amount of about 1% to 15% of the foamable sealant material, by weight.

The foamable sealant material may further comprise one or more cross-linking agents.

The cross-linking agents may include 1,1-di(tert-butylperoxy)-3,3,5-trimethylcyclohexane, dibenzoyl peroxide, benzoyl peroxide, methyl ethyl ketone peroxide, peroxydicarbonate, tertiary-butyl peroxy 2-ethyl hexanoate, tertbutyl hydroperoxide, tertbutyl peracetate, tertbutyl perbenzoate, benzoyl peroxide, tert-amyl peroxybenzoate, tert-amyl peroxy-2-ethyl hexanoate, 2,4-pentanedione peroxide, cumyl hydroperoxides, cumene hydroperoxide, dicumene peroxide, or any combination thereof.

The foamable sealant material may further comprise one or more cross-linking coagents, one or more hydrocarbon resins, carbon black, oleamide, or any combination thereof.

The present disclosure provides for a method for producing a foamable sealant material that may address at least some of the desires identified above. The method may comprise pre-compounding the zinc carboxylate salt with at least a portion of the one or more polymeric materials. The method may comprise compounding the pre-compound with the remaining portion of the one or more polymeric materials, if any, with the azodicarbonamide and the water insoluble urea or guanidine derivative.

The method may comprise heating the foamable sealant material to about 160 °C or less, more preferably about 140 °C or less, or even more preferably 120 °C or less.

The foamable sealant material may be heated for about 25 minutes or less, or even more preferably about 20 minutes or less.

The method may comprise causing the foamable sealant material to increase in volume by about 150% or more, 300% or more, 500% or more, 800% or more, 1,000% or more, 1,200% or more, or even 1,400% or more; and causing the foamable sealant material to increase in volume by about 2,200% or less, 2,000% or less, 1,800% or less, or even 1,600% or less.

### DESCRIPTION

The present disclosure provides a foamable sealant material. The foamable sealant material may be heat-activated. The foamable sealant material may foam and/or cross-link at low temperatures relative to conventional foamable sealant materials. The foamable sealant material may be a thermoplastic or a thermoset.

The foamable sealant material may foam and/or cross-link at a temperature of about 160 °C or less, 140 °C or less, or even 120 °C or less.

The foamable sealant material may have long-term latency. That is, the foamable sealant material may maintain desirable heat activation response as a function of storage time.

The foamable sealant material may foam and/or cross-link within 20 minutes or less, 15 minutes or less, or even 10 minutes or less, after the foamable sealant material and/or the substrate (e.g., a metal substrate) on which the foamable sealant material is disposed reaches a target temperature (e.g., the temperature of the oven). By way of example, during a 25 minute bake cycle, it may take about 10 minutes for a substrate to reach the target temperature and then the substrate and the foamable sealant material may be exposed, for 15 minutes, to a generally constant temperature.

The foamable sealant material may volumetrically expand by about 150% or more, about 300% or more, about 500% or more, about 800% or more, about 1,000% or more, about 1,200% or more, or even about 1,400% or more. The foamable sealant material may volumetrically expand by about 2,200% or less, about 2,000% or less, about 1,800% or less, or even about 1,600% or less.

The foamable sealant material may realize substantially no loss of volumetric expansion even after being exposed to moisture (e.g., elevated humidity) prior to foaming and/or cross-linking. The foamable sealant material exposed to moisture prior to foaming and/or cross-linking may have a loss of volumetric expansion of about 10% or less, 5% or less, or even 1% or less, relative to the fully expanded volume when not exposed to moisture. The foregoing may be applicable to exposure of the foamable material to a temperature of about 35 °C or less, a relative humidity of 85% or less, and storage for 3 days or less.

The foamable sealant material may comprise one or more foaming agents (“blowing agent”). The foaming agent may function to release gas. The gas may cause the sealant material to foam. The gas may be trapped in the polymeric matrix of the foamable sealant material, forming a cell structure. The gas may be trapped more effectively by cross-linking of the polymeric matrix.

The foaming agent may include a chemical foaming agent. Chemical foaming agents may chemically react (decompose) to release gas (e.g., nitrogen, carbon monoxide, carbon dioxide, ammonia gas, or any combination thereof). The chemical reaction may be activated by heat (thermal decomposition). The chemical reaction may be exothermic (i.e., liberating heat during decomposition). Thus, heat produced by the chemical reaction may supplement the heat provided by one or more external sources. The foaming agent may thermally decompose to release gas.

The foaming agent may include azodicarbonamide (“ADCA”). The foaming agent may include at least ADCA and optionally one or more other foaming agents.

Particle size of the foaming agent may function to modulate the rate of gas evolution at lower temperatures. Generally, the rate of gas evolution increases as the average particle size of the foaming agent decreases. The particle size distribution of the foaming agent may have a D90 of about 20 microns or less, more preferably about 15 microns or less, or even more preferably about 10 microns or less. The particle size distribution of the foaming agent may have a D90 of about 1 micron or more, 2 microns or more, 4 microns or more, or even 6 microns or more. Particle size distribution may be determined according to ASTM UOP856-07, incorporated herein by reference for all purposes.

The foaming agent may be present in an amount of about 15% or less, about 13% or less, or even about 11% or less, of the foamable sealant material by weight. The foaming agent may be present in an amount of about 2% or more, about 3% or more, about 5% or more, about 7% or more, or even about 9% or more, of the foamable sealant material by weight.

The foamable sealant material may comprise one or more foaming agent activators (“activators”). The foaming agent activator may function to reduce the activation temperature of one or more foaming agents, relative to the activation temperature thereof with no foaming agent activator present. The foaming agent activator may also change the relative ratio of gas decomposition products produced.

The activation temperature may be reduced to about 160 °C or less, about 140 °C or less, or even about 120 °C or less. The activation temperature may be reduced to about 90 °C or more, about 100 °C or more, or even about 110 °C or more.

With one or more activators present, the foaming agent may completely decompose or nearly completely decompose (e.g., decompose about 95% or more, about 97% or more, or even about 99% or more) in 20 minutes or less, 15 minutes or less, 10 minutes or less, or even 5 minutes or less at the aforementioned temperatures.

The activators may include one or more nitrogen-containing compounds, one or more zinc-containing compounds (e.g., salts of long chain fatty acids), or both. The nitrogen-containing compounds may be solid. Solid, as referred to herein, may mean solid at room temperature (i.e., about 20 °C to 22 °C).

The foamable sealant material may comprise at least one or more nitrogen-containing compounds. To achieve lower activation temperatures than can be achieved by nitrogen-containing compounds alone, zinc-containing compounds may be added to the foamable sealant material. While most zinc complexes aid in enhanced activation of foaming agent (e.g., ADCA) decomposition, specific zinc complexes, as discussed herein, may be employed to achieve particularly desirable properties.

The zinc-containing compounds and/or nitrogen-containing compounds may result in low water absorption of the foamable sealant material. This may be particularly realized in polymeric systems comprised of ethylene containing polymers and copolymers (e.g., ethylene vinyl acetate and/or ethylene butyl acrylate, as well as others discussed hereinbefore).

The zinc-containing compounds and/or nitrogen-containing compounds may allow the incorporation of polymers and/or resins with reactive groups (e.g., acrylic or epoxy functional groups) into the foamable sealant material. That is, the zinc-containing compounds and nitrogen-containing compounds may not be reactive with the reactive groups of the polymers and/or resins.

The nitrogen-containing compounds may include urea, guanidine, a modified urea compound, a modified guanidine compound, or any combination thereof. The modified urea and/or modified guanidine compounds may be modified for low water solubility.

The nitrogen-containing compounds may include dicyandiamide. Dicyandiamide may have a lower water solubility relative to other nitrogen-containing compounds typically employed as activators (e.g., urea and some substituted ureas). Dicyandiamide is generally known to be readily available from multiple commercial sources and may have a lower cost relative to other nitrogen-containing compounds.

Dicyandiamide may react with and/or cross-link epoxide functional groups. Its activity in regard to the epoxide addition reaction is heat activated and may occur at temperatures within the typical, un-modified range of ACDA activation (not the modified range of ACDA activation temperatures discussed herein). Thus, the activators of the present teachings can be formulated with epoxy resins and epoxy functional polymers (e.g., those containing glycidyl methacrylate as a comonomer).

The nitrogen-containing compound may be present in an amount of about 0.5% or more, about 1.0% or more, about 1.5% or more, about 2.0% or more, or even about 2.5% or more, of the foamable sealant material by weight. The nitrogen-containing compound may be present in an amount of about 5% or less, about 4.5% or less, about 4.0% or less, about 3.5% or less, or even about 3.0% or less, of the foamable sealant material by weight.

Zinc oxide may activate ADCA and enhance the activation of some nitrogen-containing compounds (e.g., urea or guanidine). However, because of the low solubility and extremely high melting point, the activity of zinc oxide depends on particle size and provides negligible additional reduction in activation temperature once a threshold of about 1% to 2% is reached. Zinc oxide has the additional benefit of having high thermal conductivity compared to many common mineral fillers (for example limestone, talc, or clay) as discussed below. Thus, zinc oxide may function as both an activator and a thermally conductive filler.

The zinc-containing compounds may include inorganic and/or organic zinc salts. An example of inorganic zinc salts may include zinc phosphate. The organic zinc salts may include zinc salts of organic acids (e.g., benzene sulfinic acid or acetic acid).

The zinc-containing compounds may include one or more zinc carboxylate salts. The one or more zinc carboxylate salts may be preferrable, alone or in combination, with one or more other zinc-containing compounds. The zinc carboxylate salts may be water insoluble, hydrophobic, or both. In this regard, lower water absorption; negligible (i.e., 10% reduction or less) or no reduction in expansion of the foamable sealant material; production of excellent cell structure, even after exposure to humidity of about 85% or less for extended periods (i.e., about 1 day or more, about 2 days or more, or even about 3 days or more); or any combination thereof may be realized.

Lower molecular weight (i.e., C13 carbon chain or less) zinc carboxylate salts (e.g., zinc acetate) may be effective co-activators of the insoluble urea or guanidine derivatives. However, lower molecular weight zinc carboxylate salts may have higher moisture absorption; lower volumetric expansion; and poorer cell structure after humidity exposure, relative to higher molecular weight (i.e., C14 carbon chain or more) zinc carboxylate salts.

The zinc salts of long chain carboxylic acids may be characterized by one or more carbon chains of C6 or greater, C8 or greater, or even C10 or greater. The zinc salts of long chain carboxylic acids may be characterized by one or more carbon chains of C18 or less, C16 or less, or even C14 or less. The zinc salts of long chain carboxylic acids may be saturated or unsaturated. The zinc salts of long chain carboxylic acids may include a single carbon chain length or more. Multiple carbon chain lengths may be characterized by the same or different lengths. The long chain carboxylic acids may be linear, branched, or a mixture thereof. The zinc salts of long chain carboxylic acids may be solid or liquid at room temperature (i.e., about 20 °C to 22 °C.). Liquid zinc salts of long chain carboxylic acids may be advantageous in achieving complete distribution of the material throughout the polymeric composition and for improved adhesion.

The zinc carboxylate salts may include zinc salts of long chain carboxylic acids, zinc stearate, zinc laurate, zinc caprylate, zinc neodecanoate, zinc 2-ethylhexanoate, zinc octoate, or any combination thereof. Zinc salts of long chain carboxylic acids may be preferrable.

Zinc neodecanoate may be employed for its ease of dispersion, hydrophobicity, and reduced impact on adhesion properties. Zinc neodecanoate may be preferred, alone or in combination with one or more other zinc-containing compounds.

Zinc stearate and zinc laurate may decrease adhesion of the compositions in which they are included. Zinc stearate may be present in slightly larger amounts relative to the other zinc carboxylate salts due to its lower zinc content.

Zinc stearate and laurate may be pre-compounded with at least a portion of the polymeric material discussed herein, at a temperature of about 110 °C to 130 °C (e.g., about 120 °C), due to its higher melting temperature. In this regard, homogenous dispersion and/or distribution may be ensured. After pre-compounding, the zinc stearate and polymeric material may be cooled before adding the remaining polymer and the foaming agent. The cooling may avoid premature activation of the foaming agent.

At least a portion, or possibly all, of the long chain carboxylic acids included in the composition may be characterized by unsaturation, branching, or both. Unsaturation and branching may impart a lower melting point, adhesion, adhesive durability, or any combination thereof. The zinc carboxylate salt may comprise a blend of zinc salts of saturated and unsaturated fatty acids.

An exemplary zinc salt of long chain carboxylic acids may include Dispergum L (zinc salts of C14-C18 saturated and unsaturated fatty acids), commercially available form DOG Deutsche Oelfabrik Ges. Für chemische Erzeugnisse mbH & Co. KG.

The zinc carboxylate salt may be present in an amount of about 0.5% or more, about 1.0% or more, about 1.5% or more, about 2.0% or more, or even about 2.5% or more, of the foamable sealant material by weight. The zinc carboxylate salt may be present in an amount of about 5% or less, about 4.5% or less, about 4.0% or less, about 3.5% or less, or even about 3.0% or less, of the foamable sealant material by weight.

Where one or more zinc carboxylate salts and nitrogen-containing compounds are employed together, they may be present in a ratio, by weight, of about 0.2:1 to 1:0.2, more preferably about 0.5:1 to 1:0.5, or even more preferably about 0.8:1 to 1:0.8, of zinc carboxylate salt to nitrogen-containing compound (e.g., about 1:1). The ratio may be adjusted in accordance with the zinc content, by weight, in each of the zinc carboxylate salts.

The activator and the foaming agent may be present in a ratio, by weight, of about 1:10 to 1:1, more preferably about 1:10 to 3:10, more preferably about 1.5:10 to 2.5:10 (e.g., about 2.3:10) of activator to foaming agent.

The foamable sealant material may comprise one or more polymers. The polymer may be capable of softening, flowing, trapping gas evolved from a foaming agent, hardening, cross-linking, or any combination thereof.

The use of more than one polymeric material may be beneficial for obtaining the desired melting and/or softening properties of the polymeric matrix, for the promotion of adhesion of the resulting foamable sealant material (e.g., to the walls of a cavity, chamber, or channel which is to be scaled).

The one or more polymers may melt below the activation temperature (e.g., about 160 °C or less, about 140 °C or less, or about 120 °C or less) of the foaming agent and/or foaming agent activator. In this regard, the polymer component may be melted to compound with the other ingredients while avoiding premature activation of the foaming agent and/or foaming agent activator.

The one or more polymers may be capable of cross-linking or vulcanization to assist in the trapping of gas, to stabilize the resulting foam structure, to promote adhesion to surfaces, or any combination thereof.

The polymers may include elastomers, thermoplastic elastomers, thermoplastic polymers, or any combination thereof.

The elastomers may be liquid at room temperature (i.e., about 20 °C to 22 °C). Liquid elastomers may modify the viscosity of the material.

The elastomers may include ethylene propylene rubber (“EPR”), ethylene propylene diene monomer rubber (“EPDM”), styrene butadiene rubber (“SBR”), nitrile rubber (“NBR”), polybutadiene rubber, natural rubber, isobutylene-isoprene rubber (“IIR”), or any combination thereof.

The thermoplastic elastomers may include block copolymers of styrene with butadiene or isoprene, for example styrene-butadiene-styrene (“SBS”) or styrene-isoprene-styrene (“SIS”). The block copolymers may be hydrogenated, for example styrene-ethylene-propylene-styrene (“SEPS”) or styrene-ethylene-butylene-styrene (“SEBS”).

The thermoplastic polymers may include an ethylene monomer. The thermoplastic polymers may include polyethylene. The polyethylene may be low-density or linear low-density. The low-density polyethylene may be a homopolymer of ethylene with long chain branching. The linear low-density polyethylene may be a linear copolymer of ethylene and a low molecular weight olefin (e.g., butene, hexene or octene to produce short chain branching).

The thermoplastic polymers may include one or more copolymers of ethylene with a polar comonomer. Copolymers suitable for polymerization with ethylene may include methyl acrylate, ethyl acrylate, butyl acrylate, glycidyl methacrylate, acrylic acid, methacrylic acid, vinyl acetate, or any combination thereof.

The thermoplastic polymers may include a terpolymer. The third monomer may be a functional monomer (i.e., possessing a reactive functional group). The functional monomer may be a monomer with an additional reactive site capable of participating in cross-linking the polymeric composition and/or interacting with a surface to promote adhesion. The functional monomer may include glycidyl methacrylate (“GMA”), acrylic acid, methacrylic acid, maleic anhydride, or any combination thereof.

An additional reactive site may be obtained by grafting a functional monomer onto polyethylene and/or an ethylene copolymer.

Exemplary polymers may include ethylene n-butyl acrylate copolymer, ethylene vinyl acetate copolymer, ethylene n-butyl acrylate glycidyl methacrylate terpolymer, or any combination thereof.

The ethylene n-butyl acrylate copolymer may have a butyl acrylate content of about 15% to 40%. The ethylene vinyl acetate copolymer may have a vinyl acetate content of about 15% to 30%. The ethylene butyl acrylate glycidyl methacrylate terpolymer may have a butyl acrylate content of about 20% to 30% and a glycidyl methacrylate content of about 6% to 10%.

The ethylene n-butyl acrylate copolymer may have a melt flow index of about 1 g/10 min to 1,000 g/10 min. The ethylene vinyl acetate copolymer may have a melt flow index of about 1 g/10 min to 1,000 g/10 min. The ethylene n-butyl acrylate glycidyl methacrylate may have a melt flow index of about 1 g/10 min to 1,000 g/10 min. Melt flow index may be measured according to ASTM D1238.

The melt flow index of the one or more polymers may be selected in view of the desired expansion volume of the foamable sealant material. That is, polymers that have a lower degree of flow may expand less than a polymer having a higher degree of flow. This is taken in view of the other ingredients of the foamable sealant material, which may affect the rheological properties thereof. A melt flow index that is too low may result in constraining the formation and/or dimensions of cells resulting from gas evolution. A melt flow index that is too high may diminish the gas trapping ability of the polymer matrix.

The one or more polymers may present in an amount of about 70% or less, about 65% or less, or even about 60% or less, of the foamable sealant material by weight. The one or more polymers may be present in an amount of about 40% or more, about 45% or more, or even about 50% or more, of the foamable sealant material by weight.

The foamable sealant material may comprise one or more cross-linking agents. The cross-linking agent may function to create bonds between polymer molecules.

The polymer system may be cross-linked. Polymeric materials that include unsaturation (i.e., carbon to carbon double bonds) can be crosslinked with elemental sulfur or a combination of sulfur and a cure accelerator. Exemplary cross-linking agents may include dithiocarbamates, benzothiazoles (e.g., 2-mercapto-benzothiazole (“MBT”), 2-2′-dithiobis(benzothiazole) (“MBTS”)), thioureas, thiruams, and guanidines.

Carboxylated elastomers and thermoplastics can be crosslinked with hexamethylene diamine carbamate. Polymers containing glycidyl methacrylate can be crosslinked with latent amine curatives such as adipic acid dihydrazide (“ADH”) and dicyandiamide.

The crosslinking agent may include a latent organic peroxide. Latent organic peroxides are those which have a half-life of about 1 week to 6 months at room temperature (i.e., about 20 °C to 22 °C) but much shorter half-life (e.g., 1 hour or less) at the activation temperature of the foaming agent and foaming agent activators. Peroxides can be used to crosslink polymers with and without unsaturation in their structure.

Suitable organic peroxides may include dicumyl peroxide, di-(tert-butyl peroxy isopropyl)benzene, butyl 4,4-di(tert-butylperoxy) valerate, benzoyl peroxide, methyl ethyl ketone peroxide, peroxydicarbonate, tertiary-butyl peroxy 2-ethyl hexanoate, tertbutyl hydroperoxide, tertbutyl peracetate, tertbutyl perbenzoate, benzoyl peroxide, tert-amyl peroxybenzoate, tert-amyl peroxy-2-ethyl hexanoate, 2,4-pentanedione peroxide, cumyl hydroperoxides, cumene hydroperoxide, dicumene peroxide, or any combination thereof. Preferrable peroxides may include 1,1-di(tert-butylperoxy)-3,3,5-trimethylcyclohexane, dibenzoyl peroxide, or any combination thereof.

To assist in trapping of gases at temperature of about 140 °C or lower, preferred organic peroxides are those with a short half-life of 6 minutes or less at temperatures of about 140 °C. Preferred organic peroxides may include 1,1-di(tert-butylperoxy)-3,3,5-trimethylcyclohexane, dibenzoyl peroxide, or both.

The cross-linking agent may present in an amount of about 3% or less, about 2.5% or less, or even about 2% or less, of the foamable sealant material by weight. The cross-linking agent may be present in an amount of about 0.5% or more, about 1% or more, about 1.5% or more, or even about 2% or more, of the foamable sealant material by weight.

The foamable sealant material may comprise one or more cross-linking coagents (“coagent”). The coagents may function to enhance crosslinking, influence peroxide decomposition temperature range, facilitate trapping of gases generated by the foaming agent, or both.

The coagent may be difunctional, trifunctional, or multifunctional. The coagent may include acrylate compounds, methacrylate compounds, vinylic compounds, allylic compounds, aliphatic maleimide compounds, aromatic maleimide compounds, or any combination thereof.

Suitable acrylate or methacrylate coagents may include dipentaerythritol pentaacrylate, dipentaerythritol hexaacrylate, trimetholyl propane triacrylate, trimetholyl propane trimethacrylate, ethoxylated bisphenol A diacrylates, ethoxylated bisphenol A dimethacrylates, or any combination thereof.

Suitable vinyl coagents may include divinyl benzene, cyclohexanedimethanol divinyl ether, or both.

Suitable allylic coagents may include triallyl cyanurate, triallyl isocyanurate, or both.

Suitable maleimide coagents may include N,N′-m-phenylenedimaleimide, phenylmethane maleimide (CAS Number 67784-74-1), or both.

The coagent may present in an amount of about 3% or less, about 2% or less, about 1% or less, or even about 0.5% or less, of the foamable sealant material by weight. The coagent may be present in an amount of about 0.05% or more, about 0.1% or more, about 0.2% or more, or even about 0.3% or more, of the foamable sealant material by weight. The content of coagent in the foamable sealant material may be selected based on the functionality of the polymers, the desired reaction rate, or both.

The foamable sealant material may comprise one or more hydrocarbon resins. The hydrocarbon resin may function to improve processing by lowering viscosity at elevated temperatures, promote adhesion to some types of substrates, or both.

The hydrocarbon resin may have a softening point of about 80 °C or more, about 85 °C or more, or even about 90 °C or more. The hydrocarbon resin may have a softening point of about 110 °C or less, about 105 °C or less, or even about 100 °C or less.

The hydrocarbon resin may include a C5 resin, a C9 resin, hydrocarbons derived from coumarone, rosin-based resins, or any combination thereof.

The hydrocarbon resin may present in an amount of about 20% or less, about 18% or less, about 16% or less, or even about 14% or less, of the foamable sealant material by weight. The hydrocarbon resin may be present in an amount of about 5% or more, about 8% or more, about 10% or more, or even about 12% or more, of the foamable sealant material by weight.

The foamable sealant material may comprise one or more thermally conductive fillers. The thermally conductive filler may function to enhance the activation rate of the foaming agent (i.e., shorten the time required to achieve full decomposition). This may be achieved by increasing the rate of heat transfer into the foamable sealant material.

The thermally conductive filler and foaming agent activators may cooperate in controlling foaming of the material by reducing the activation temperature inherent to the foaming agent and reducing the time to full volumetric expansion.

The thermally conductive filler may include any thermally conductive particulate constituent that has a cost/volume ratio that enables economical use in sealant materials, with particularly preferred options including iron powder, aluminum powder, zinc powder, aluminum nitride, aluminum oxide (“alumina”), zinc oxide, graphite, graphene, iron phosphide, strontium ferrite, graphitic boron nitride, silicon carbide, or any combination thereof.

The thermally conductive filler may present in an amount of about 30% or less, about 25% or less, or even about 20% or less, of the foamable sealant material by weight. The thermally conductive filler may be present in an amount of about 2% or more, about 5% or more, about 10% or more, or even about 15% or more, of the foamable sealant material by weight.

In some aspects, the thermally conductive filler may be present in the foamable material up to about 40% or even about 50%, by weight. The preferred weight percentage of thermally conductive filler may depend on the properties of the thermally conductive filler, particularly its level of thermal conductivity; and particle size, shape, and density. In this regard, it is contemplated that these higher contents of thermally conductive filler may be used in formulations for lower degrees of volumetric expansion (e.g., about 1,000% or less, about 800% or less, or even about 500% or less). That is, as the content of polymer decreases to accommodate for the increased volumetric content of thermally conductive filler, there may be less polymer matrix to provide for the formation of cells via gas evolution.

Zinc oxide represents a unique case of a material that is both an activator of ADCA and also has relatively high thermal conductivity. Thus, at levels of zinc oxide of, e.g., about 15% by weight, there may be minimal benefit in volumetric expansion at, e.g., about 140 °C for about 25 minutes, with addition of a zinc carboxylate compound. Still, the addition of a zinc carboxylate compound can enhance the volumetric expansion at shorter bake times (e.g., about 15 minutes) and lower bake temperatures (e.g., about 135 °C) and may also provide improvements to expansion after exposure of the un-activated foamable sealant material to high humidity. These benefits are illustrated in Table 7A and Table 7B, below.

The foamable sealant composition may comprise one or more antioxidants. The antioxidant may function to improve the temperature range over which the material foams while reducing the propensity toward degradation as a result of temperature exposure. The antioxidant may have no detrimental effect on the volumetric expansion and cell structure (i.e., having little if any effect on the foaming activation temperature or decomposition rate).

The antioxidant may allow the foamable sealant composition to be utilized at temperatures of about 170 °C or more (e.g., about 180 °C or more, about 190 °C or more, or even about 200 °C or more), improving the expansion at these temperatures. While the present teachings discuss activation temperatures as low as 120 °C or less, the foamable sealant composition typically should have consistent expansion at higher temperatures in case it is exposed to higher temperatures. For example, in high throughput manufacturing operations, oven temperatures may run higher than the desired activation temperature in order to heat up the parts and the composition more rapidly, although the cycle time may be sufficiently fast to avoid the parts and/or the composition from themselves heating up to the oven temperature. However, the composition should still provide consistent expansion at the oven temperature (e.g., about 180 °C, about 190 °C, or even about 200 °C) in case equipment malfunctions or otherwise extends the cycle time.

Without intending to be bound by theory, some thermally conductive fillers (e.g., iron powder and aluminum powder) may activate the peroxide curing system discussed hereinbefore, causing the peroxide curing system to decompose at lower temperatures than its activation temperature. The decomposition may negatively impact expansion properties of the composition. The antioxidant may mitigate or even prevent this decomposition.

The antioxidant may be advantageous when the polymer system is crosslinked with an organic peroxide.

The antioxidant may be derived from hindered phenols. The hindered phenols may include butylated hydroxy toluene or pentaerythritol tetrakis(3-(3,5-di-tert-butyl-4-hydroxyphenyl) propionate).

The antioxidant may present in an amount of about 2.5% or less, about 2% or less, or even about 1.5% or less, of the foamable sealant material by weight. The antioxidant may be present in an amount of about 0.1% or more, about 0.5% or more, or even about 1% or more, of the foamable sealant material by weight.

The foamable sealant composition may comprise one or more anti-blocking agents or mold release agents. An exemplary anti-blocking or mold release agent may include oleamide. The anti-blocking or mold release agent may be present in an amount of about 0.1% or more, about 0.3% or more, or even about 0.5% or more, of the foamable sealant material by weight. The anti-blocking or mold release agent may be present in an amount of about 1.1% or less, about 0.9% or less, or even about 0.7% or less, or the foamable sealant material by weight.

### Examples

Table 1 provides a listing of abbreviations and descriptions for the ingredients employed throughout the examples. Where a detailed description is not required, the ingredient name is provided in the examples.

TABLE 1

| Ingredient | Description |
|---|---|
| EnBA | Ethylene, n-butyl acrylate copolymer, |
| | 35% BA, 40 MFR |
| EVA | Ethylene vinyl acetate copolymer, |
| | 18% VA, 150 MFR |
| EVA-2 | Ethylene vinyl acetate copolymer, |
| | 40% VA, 52 MFR |
| EnBA-GMA | Ethylene, n-butyl acrylate GMA terpolymer, |
| | 25% BA, 8% GMA, 7 MFR |
| EEA-MA | Ethylene, ethyl acrylate, maleic anhydride |
| | terpolymer, 18% EA, 3% MA, 70 MFR |
| EPDM | 2:1 E:P, 40 Mooney @ 125 °C, ~3% DCDP |
| EPDM-2 | 2:1 E:P, 60 Mooney @ 125 °C, ~5% ENB |
| EPDM-L | Liquid EPDM, ~5% ENB |
| PIB | Liquid polyisobutylene, ~645 cSt at 100 °C |
| PIB-2 | Liquid polyisobutylene, ~3100 cSt at 100 °C |
| Hydrocarbon | C9 hydrocarbon resin, softening point 110 °C |
| Resin | |
| CI Resin | Coumarone-indene resin, softening point 100 °C |
| C5/C9 Resin | Aromatically modified C-5 resin, softening |
| | point 87 °C |
| Process Oil | ~70% paraffinic, 480 cSt @ 40 °C |
| Antioxidant | Sterically hindered phenolic antioxidant |
| CaCO₃ - 4 | Ground Limestone, ~4 micron |
| CaCO₃ - 325 | Ground Limestone, ~325 Mesh |
| Iron Powder | Iron powder |
| Iron Phosphide | Iron phosphide |
| Strontium | Strontium ferrite |
| Ferrite | |
| Aluminum | Aluminum powder - spherical |
| Powder | |
| Boron Nitride | Boron nitride |
| Peroxide-40 | 1,1-di(tert-butylperoxy)-3,3,5-trimethylcyclohexane, |
| | 40% active |
| BPO-50 | Dibenzoyl Peroxide, 50% active |
| BPO-75 | Dibenzoyl Peroxide, 75% active |
| Coated Urea | Sulfur Coated Urea |
| Zinc Oxide | Zinc oxide |
| Dicyandiamide 1 | Dicyandiamide, ~7 microns |
| Dicyandiamide 2 | Dicyandiamide, ~9 microns |
| Pigment | Carbon black |
| ADCA | Azodicarbonamide |
| DPHA | Dipentaerithrytol pentaacrylate, hexacrylate blend |
| TMPTMA | Trimethylol propane trimethacrylate |
| Zn NDA | Zinc salt of neodecanoic acid (Zinc neodecanoate) |
| Zinc salts, | Fatty acids, C14-18 and C16-18-unsatd., zinc salts |
| long chain | |
| carboxylic acids | |
| Oleamide | Oleamide |

Table 2A sets forth Inventive Examples I-1 through I-4 and Comparative Examples C-1 through C-2, containing dicyandiamide and an aliphatic zinc carboxylate in varying combinations. The formulations were heated to foam the materials under the following conditions: initially after compounding, after 3 days storage at 35 °C and 85% relative humidity, and after 3 days storage at 54 °C. Volumetric expansion was conducted at 140 °C and 190 °C for 25 minutes and 30 minutes, respectively. Table 2B summarizes the test results. The testing demonstrates that compositions containing both dicyandiamide and aliphatic zinc carboxylate salts have improved volumetric expansion at an exposure condition of 140 °C for 25 minutes. The benefit of this activator combination is obtained in exposure to high humidity for an extended period of time prior to heat activation, in this case 3 days.

In the following tables reporting test results, the percentage of volume expansion (% Exp) relative to the green state of the compositions (i.e., prior to expansion) due to activation (e.g., at 140 °C/25 min.) and the percentage of retained volume (% Ret) after storage in exposure conditions (e.g., 3 Days at 35 °C/85% R.H.) are given. Moisture content, where provided below, was determined according to ASTM D6304-20, incorporated herein by reference for all purposes.

Density, as reported in the following examples, may be measured according to ASTM D1505, incorporated herein by reference for all purposes.

TABLE 2A

| | Ex. | Ex. | Ex. | Ex. | Ex. | Ex. |
|---|---|---|---|---|---|---|
| Ingredients | C-1 | I-1 | I-2 | C-2 | I-3 | I-4 |
| EnBA | 28.16 | 27.60 | 27.86 | 27.86 | 27.73 | 27.73 |
| EVA | 22.51 | 22.06 | 22.28 | 22.28 | 22.17 | 22.17 |
| EnBA-GMA | 5.72 | 5.61 | 5.67 | 5.67 | 5.64 | 5.64 |
| Hydrocarbon | 15.86 | 15.54 | 15.70 | 15.70 | 15.62 | 15.62 |
| Resin | | | | | | |
| Antioxidant | 1.02 | 1.00 | 1.01 | 1.01 | 1.01 | 1.01 |
| Aluminum | 10.37 | 10.25 | 10.35 | 10.35 | 10.30 | 10.30 |
| Powder | | | | | | |
| Peroxide-40 | 1.53 | 1.50 | 1.52 | 1.52 | 1.51 | 1.51 |
| BPO-50 | 0.61 | 0.60 | 0.61 | 0.61 | 0.60 | 0.60 |
| Zinc Oxide | 3.06 | 3.00 | 3.03 | 3.03 | 3.02 | 3.02 |
| Dicyandiamide | — | 1.00 | 1.01 | — | 0.50 | 1.01 |
| 1 | | | | | | |
| Oleamide | 0.82 | 0.80 | 0.81 | 0.81 | 0.80 | 0.80 |
| Pigment | 0.10 | | | | | |
| ADCA | 9.69 | 9.50 | 9.60 | 9.60 | 9.55 | 9.55 |
| DPHA | 0.55 | 0.54 | 0.55 | 0.55 | 0.54 | 0.54 |
| Zinc salts, | — | 1.00 | — | 1.01 | 1.01 | 0.50 |
| long chain | | | | | | |
| carboxylic | | | | | | |
| acids | | | | | | |
| TOTAL | 100.00 | 100.00 | 100.00 | 100.00 | 100.00 | 100.00 |

TABLE 2B

| Ex. C-1 | | Ex. I-1 | | Ex. I-2 | | Ex. C-2 | |
|---|---|---|---|---|---|---|---|
| % | % | % | % | % | % | % | % |
| Exp | Ret | Exp | Ret | Exp | Ret | Exp | Ret |

% Volume Expansion, Initial

| | | | | | | | | |
|---|---|---|---|---|---|---|---|---|
| 140 °C/25 min. | 40 | NA | 2060 | NA | 1856 | NA | 68 | NA |
| 190 °C/30 min. | 1948 | NA | 2376 | NA | 2279 | NA | 2058 | NA |

% Volume Expansion, 3 Days at 35 °C/85% R.H.

| | | | | | | | | |
|---|---|---|---|---|---|---|---|---|
| 140 °C/25 min. | 27 | 68 | 1863 | 90 | 1596 | 86 | 60 | 88 |
| 190 °C/30 min. | 2301 | 118 | 2352 | 99 | 2479 | 109 | 2031 | 99 |

% Volume Expansion, 3 Days at 54 °C

| | | | | | | | | |
|---|---|---|---|---|---|---|---|---|
| 140 °C/25 min. | 35 | 88 | 2051 | 100 | 1818 | 98 | 63 | 93 |
| 190 °C/30 min. | 2061 | 106 | 2358 | 99 | 2299 | 101 | 1930 | 94 |

| | |
|---|---|
| Ex. I-3 | Ex. I-4 |

| | | | |
|---|---|---|---|
| % Exp | % Ret | % Exp | % Ret |

% Volume Expansion, Initial

| | | | | |
|---|---|---|---|---|
| 140 °C/25 min. | 1893 | NA | 1938 | NA |
| 190 °C/30 min. | 2346 | NA | 2363 | NA |

% Volume Expansion, 3 Days at 35 °C/85% R.H.

| | | | | |
|---|---|---|---|---|
| 140 °C/25 min. | 1678 | 89 | 1707 | 88 |
| 190 °C/30 min. | 2324 | 99 | 2411 | 102 |

% Volume Expansion, 3 Days at 54 °C

| | | | | |
|---|---|---|---|---|
| 140 °C/25 min. | 1865 | 99 | 1870 | 96 |
| 190 °C/30 min. | 2332 | 99 | 2374 | 100 |

A combination of dicyandiamide and zinc salts of long chain carboxylic acids can increase the expansion compared to either component present without the other.

Table 3A sets forth Inventive Examples I-5 and I-6, containing a thermally conductive filler. The non-conductive calcium carbonate filler of Comparative Example C-3 was replaced with the thermally conductive filler at a nearly 1:1 volumetric substitution. Inventive Example I-6 further comprises an antioxidant. The formulations were volumetrically expanded initially after compounding, after 3 days storage at 35 °C and 85% relative humidity, and after 3 days storage at 54 °C. Volumetric expansion was conducted at 140 °C and 190 °C for 25 minutes and 30 minutes, respectively. Table 3B summarizes the test results. The testing demonstrates some benefits of adding the thermally conductive filler to enhance low temperature 140 °C expansion relative to Comparative Example C-3. The overall foaming behavior can benefit, in some circumstances, by addition of an antioxidant as demonstrated in Inventive Examples I-6, I-8, and I-9, where the expansion level at elevated activation temperature, which was decreased in Inventive Example I-5, can be improved by addition of an antioxidant. Antioxidant is particularly beneficial with some conductive fillers such as the iron and other metals because the metals are capable of activating the decomposition of the organic peroxide curatives.

TABLE 3A

| Ingredients | Ex. C-3 | Ex. I-5 | Ex. I-6 |
|---|---|---|---|
| EnBA | 28.65 | 23.70 | 23.70 |
| EVA | 22.40 | 18.53 | 18.53 |
| EnBA-GMA | 5.90 | 4.88 | 4.88 |
| Hydrocarbon Resin | 15.80 | 13.07 | 13.07 |
| Antioxidant | — | — | 0.30 |
| CaCO₃ - 4 | 10.34 | — | — |
| Iron Powder | — | 25.83 | 24.29 |
| Peroxide-40 | 1.50 | 1.24 | 1.24 |
| BPO-50 | 0.60 | 0.50 | 0.50 |
| Zinc Oxide | 3.00 | 2.48 | 2.48 |
| Dicyandiamide 1 | 1.00 | 0.83 | 0.83 |
| Oleamide | 0.80 | 0.66 | 0.66 |
| Pigment | 0.11 | 0.09 | 0.09 |
| ADCA | 8.50 | 7.03 | 8.00 |
| DPHA | 0.40 | 0.33 | 0.43 |
| Zinc salts, long chain | 1.00 | 0.83 | 1.00 |
| carboxylic acids | | | |
| TOTAL | 100.00 | 100.00 | 100.00 |
| Density (g/cc) | 1.11 | 1.34 | 1.33 |

TABLE 3B

| | | |
|---|---|---|
| Ex. C-3 | Ex. I-5 | Ex. I-6 |
| % Exp | % Exp | % Exp |

% Volume Expansion, Initial

| | | | |
|---|---|---|---|
| 140 °C/25 min. | 1800 | 1793 | 2003 |
| 163 °C/30 min. | 2125 | 1887 | 2275 |
| 177 °C/30 min. | 2155 | 1643 | 2011 |
| 190 °C/30 min. | 2138 | 862 | 1445 |

% Volume Expansion 3 Days at 35 °C/85% R.H.

| | | | |
|---|---|---|---|
| 140 °C/25 min. | 1367 | 1619 | 1814 |
| 163 °C/30 min. | 2083 | 1760 | 2218 |
| 190 °C/30 min. | 2125 | 299 | 830 |
| Moisture content (%) | 0.13 | 0.11 | 0.11 |

% Volume Expansion, 3 Days at 54 °C

| | | | |
|---|---|---|---|
| 140 °C/25 min. | 1738 | 1772 | 2013 |
| 163 °C/30 min. | 2059 | 1810 | 2235 |
| 190 °C/30 min. | 2033 | 997 | 1411 |

Table 4A sets forth Inventive Examples I-7 through I-9, containing an antioxidant. The formulations were volumetrically expanded initially after compounding, after 3 days storage at 35 °C and 85% relative humidity, and after 3 days storage at 54 °C. Volumetric expansion was conducted at 140 °C, 163 °C, 177 °C, and 190 °C. Table 4B summarizes the test results. The testing further demonstrates some benefits of adding an antioxidant on foaming performance, which is generally more pronounced at the higher activation temperatures.

TABLE 4A

| Ingredients | Ex. I-7 | Ex. I-8 | Ex. I-9 |
|---|---|---|---|
| EnBA | 23.70 | 23.70 | 23.20 |
| EVA | 18.53 | 18.53 | 18.53 |
| EnBA-GMA | 4.88 | 4.71 | 4.71 |
| Hydrocarbon Resin | 13.07 | 13.07 | 13.05 |
| Antioxidant | — | 0.40 | 1.00 |
| Iron Powder | 24.35 | 24.35 | 24.35 |
| Peroxide-40 | 1.24 | 1.24 | 1.24 |
| BPO-50 | 0.50 | 0.50 | 0.50 |
| Zinc Oxide | 2.48 | 2.48 | 2.48 |
| Dicyandiamide 1 | 0.83 | 0.83 | 0.83 |
| Oleamide | 0.50 | 0.66 | 0.66 |
| Pigment | 0.09 | — | — |
| ADCA | 8.00 | 8.00 | 8.00 |
| DPHA | 0.53 | 0.53 | 0.45 |
| Zinc salts, long chain | 1.00 | 1.00 | 1.00 |
| carboxylic acids | | | |
| TOTAL | 99.70 | 100.00 | 100.00 |
| Density (g/cc) | 1.32 | 1.32 | 1.33 |

TABLE 4B

| | | |
|---|---|---|
| Ex. I-7 | Ex. I-8 | Ex. I-9 |
| % Exp | % Exp | % Exp |

% Volume Expansion, Initial

| | | | |
|---|---|---|---|
| 140 °C/25 min. | 2035 | 2000 | 2040 |
| 163 °C/30 min. | 2151 | 2285 | 2338 |
| 177 °C/30 min. | 1066 | 2169 | 2323 |
| 190 °C/30 min. | 639 | 1580 | 2219 |

% Volume Expansion after 3 Days at 95 °F/85% R.H.

| | | | |
|---|---|---|---|
| 140 °C/25 min. | — | 1867 | 1847 |
| 163 °C/30 min. | — | 2276 | 2314 |
| 177 °C/30 min. | — | 2221 | 2305 |
| 190 °C/30 min. | — | 1435 | 2268 |
| Moisture Content (%) | NA | 0.088 | 0.128 |

% Volume Expansion, 3 Days at 54 °C

| | | | |
|---|---|---|---|
| 140 °C/25 min. | — | 2031 | 2047 |
| 163 °C/30 min. | — | 2262 | 2334 |
| 177 °C/30 min. | — | — | 2349 |
| 190 °C/30 min. | — | 1506 | 2321 |

Table 5A sets forth Inventive Examples I-10 through I-13, containing various thermally conductive fillers. The fillers were substituted so each example contains a nearly equal volumetric quantity of each ingredient including the conductive filler. The formulations were volumetrically expanded initially after compounding, after 3 days storage at 35 °C and 85% relative humidity, and after 3 days storage at 54 °C. Volumetric expansion was conducted at 140 °C, 163 °C, 177 °C, and 190 °C. Table 5B summarizes the test results. Generally, strontium ferrite performs better than iron phosphide, aluminum powder performs better than strontium ferrite, and boron nitride performs better than aluminum powder, with respect to greater volumetric expansion.

TABLE 5A

| Ingredients | Ex. I-10 | Ex. I-11 | Ex. I-12 | Ex. I-13 |
|---|---|---|---|---|
| EnBA | 24.00 | 25.48 | 27.60 | 28.24 |
| EVA | 19.33 | 20.35 | 22.06 | 22.51 |
| EnBA-GMA | 4.91 | 5.17 | 5.61 | 5.73 |
| Hydrocarbon Resin | 13.50 | 14.33 | 15.54 | 15.89 |
| Antioxidant | 1.04 | 1.10 | 1.00 | 1.22 |
| Iron phosphide | 21.40 | — | — | — |
| Strontium ferrite | — | 16.94 | — | — |
| Aluminum powder | — | — | 10.25 | — |
| Boron nitride | — | — | — | 7.91 |
| Peroxide-40 | 1.29 | 1.36 | 1.50 | 1.51 |
| BPO-50 | 0.52 | 0.55 | 0.60 | 0.60 |
| Zinc Oxide | 2.59 | 2.72 | 3.00 | 3.02 |
| Dicyandiamide 1 | 0.87 | 0.91 | 1.00 | 1.01 |
| Oleamide | 0.69 | 0.72 | 0.80 | 0.80 |
| Pigment | — | — | — | 0.05 |
| ADCA | 8.35 | 8.78 | 9.50 | 9.74 |
| DPHA | 0.47 | 0.49 | 0.54 | 0.55 |
| Zinc salts, long chain | 1.04 | 1.10 | 1.00 | 1.22 |
| carboxylic acids | | | | |
| TOTAL | 100.00 | 100.00 | 100.00 | 100.00 |
| Density (g/cc) | 1.27 | 1.21 | 1.12 | 1.10 |

TABLE 5B

| | | | |
|---|---|---|---|
| Ex. I-10 | Ex. I-11 | Ex. I-12 | Ex. I-13 |
| % Exp | % Exp | % Exp | % Exp |

% Volume Expansion, Initial

| | | | | |
|---|---|---|---|---|
| 140 °C/25 min. | 1859 | 1927 | 2058 | 2012 |
| 163 °C/30 min. | 2308 | 2328 | 2333 | 2460 |
| 177 °C/30 min. | 2339 | 2365 | 2387 | 2498 |
| 190 °C/30 min. | 2326 | 2360 | 2383 | 2464 |

% Volume Expansion after 3 Days at 95 °F/85% R.H.

| | | | | |
|---|---|---|---|---|
| 140 °C/25 min. | 1536 | 1343 | 1884 | 1900 |
| 163 °C/30 min. | 2069 | 2169 | 2302 | 2312 |
| 190 °C/30 min. | 2127 | 2204 | 2332 | 2411 |
| Moisture content (%) | 0.11 | 0.16 | 0.121 | 0.101 |

% Volume Expansion, 3 Days at 54 °C

| | | | | |
|---|---|---|---|---|
| 140 °C/25 min. | 1939 | 2010 | 2017 | 2030 |
| 163 °C/30 min. | 2310 | 2338 | 2344 | 2363 |
| 190 °C/30 min. | 2322 | 2385 | 2364 | 2389 |

Table 6A sets forth Inventive Examples I-10 through I-14, containing various carboxylate salts. The formulations were heated to expand the material initially after compounding, after 3 days storage at 35 °C and 85% relative humidity, and after 3 days storage at 54 °C. Volumetric expansion was conducted at 140 °C, 163 °C, 177 °C, and 190 °C. Table 6B summarizes the test results. The effectiveness of using a C8, C10, and C18 saturated carboxylate salt is demonstrated.

For the inventive examples, the various zinc carboxylate salts were added to provide nearly equal zinc content to the formulations. The comparative examples C-3 and C-4 incorporate zinc acetate at zinc levels slightly below and above the inventive examples. While zinc acetate provides activation of the azodicarbonamide foaming agent, it is shown that this shorter chain-length zinc carboxylate salt is more susceptible to the effects of high humidity exposure. Generally, comparatively longer chain lengths provide greater moisture resistance; a benefit that may be exhibited independent of effects from conductive fillers. Expansion is substantially degraded after a 3-day exposure to 85% relative humidity at 35 °C. This is also observed in the level of moisture uptake which ranges from about 0.3% to above 0.4% for this exposure condition depending on level of zinc acetate added while the example according to the present teachings have moisture content of less than 0.15% and even under 0.1% for the same conditions.

Example I-14 was prepared by pre-compounding the zinc compound with a portion of the polymer. It is demonstrated that it may be beneficial to pre-compound the zinc compound in one of the polymers before adding it to the formulation. This is especially the case for higher melt temperature zinc salts, where the melting point is above the preferred compounding temperature of the heat activated sealant material. For example, zinc stearate melts at about 120 °C, while the preferred maximum compound temperature for heat activated sealant material is about 95 °C, preferably 90 °C, or even more preferably 85 °C. The zinc stearate can be compounded with one of the polymeric components and no other reactive ingredients at temperatures at or above the melting point of zinc stearate to form a masterbatch and the masterbatch may be incorporated to the final formulation at lower temperature.

The aliphatic zinc carboxylate may be incorporated in a polymeric form as a zinc ionomer. Zinc ionomers of ethylene, methacrylic acid copolymers, or ethylene methacrylic acid vinyl acetate terpolymers are commercially available from Dow Chemical Company under the trade name Surlyn™. Because of the high compounding temperature of the zinc ionomers, it may be beneficial to compound the ionomer with a lower melting point component, for example an ethylene vinyl acetate resin, to lower its melting point and allow incorporation of the ionomer below the activation temperature of the heat activated foamable sealant material.

TABLE 6A

| Ingredients | Ex. C-3 | Ex. C-4 | Ex. I-10 | Ex. I-11 | Ex. I-12 | Ex. I-13 | Ex. I-14 |
|---|---|---|---|---|---|---|---|
| EnBA | 27.72 | 27.55 | 28.68 | 27.64 | 27.64 | 27.32 | 27.32 |
| EVA | 22.17 | 22.02 | 22.16 | 22.03 | 22.03 | 21.84 | 18.84 |
| EnBA-GMA | 5.64 | 5.62 | 6.00 | 5.59 | 5.59 | 5.55 | 5.55 |
| Hydrocarbon Resin | 15.70 | 15.62 | 14.66 | 15.50 | 15.50 | 15.38 | 15.38 |
| Antioxidant | 1.00 | 1.00 | 0.48 | 1.00 | 1.00 | 0.99 | 0.99 |
| Aluminum powder | 10.30 | 10.25 | 10.63 | — | — | 10.06 | 10.06 |
| CaCO₃ - 4 | — | — | — | 10.96 | 11.08 | — | — |
| Peroxide-40 | 1.51 | 1.50 | 1.05 | 1.05 | 1.05 | 1.49 | 1.49 |
| BPO-50 | 0.60 | 0.60 | 0.54 | 0.59 | 0.59 | 0.59 | 0.59 |
| Zinc Oxide | 3.02 | 3.00 | 2.83 | 2.99 | 2.99 | 2.97 | 2.97 |
| Zinc Acetate | 0.50 | 1.00 | — | — | — | — | — |
| Zn NDA | — | — | 1.22 | 1.22 | — | — | — |
| Zinc 2-ethylhexanoate | — | — | — | — | 1.10 | — | — |
| Zinc Stearate | — | — | — | — | — | 2.00 | — |
| 40% Zinc Stearate in | — | — | — | — | — | — | 5.00 |
| EVA | | | | | | | |
| Dicyandiamide 1 | 1.00 | 1.00 | 1.00 | — | — | 0.99 | 0.99 |
| Dicyandiamide 2 | — | — | — | 1.00 | 1.00 | — | — |
| Oleamide | 0.80 | 0.80 | 0.80 | 0.40 | 0.40 | 0.79 | 0.79 |
| ADCA | 9.50 | 9.50 | 9.50 | 9.50 | 9.50 | 9.50 | 9.50 |
| DPHA | 0.54 | 0.54 | 0.35 | 0.53 | 0.53 | 0.53 | 0.53 |
| TOTAL | 100.00 | 100.00 | 99.9 | 100.00 | 100.00 | 100.00 | 100.00 |

TABLE 6B

| Ex. C-3 | | Ex. C-4 | | Ex. I-10 | | Ex. I-11 | |
|---|---|---|---|---|---|---|---|
| % Exp | % Ret | % Exp | % Ret | % Exp | % Ret | % Exp | % Ret |

% Volume Expansion, Initial

| | | | | | | | | |
|---|---|---|---|---|---|---|---|---|
| 140 °C/25 min. | 1898 | NA | 1610 | NA | 2087 | NA | 1998 | NA |
| 190 °C/30 min. | 2493 | NA | 2166 | NA | 2394 | NA | 2246 | NA |

% Volume Expansion, 3 Days at 35 °C/85% R.H.

| | | | | | | | | |
|---|---|---|---|---|---|---|---|---|
| 140 °C/25 min. | 945 | 50 | 758 | 47 | 2014 | 97 | 1955 | 98 |
| 190 °C/30 min. | 894 | 36 | 590 | 27 | 2500 | 104 | 2512 | 112 |

| | | | | |
|---|---|---|---|---|
| Moisture Content (%) | 0.296 | 0.415 | 0.140 | 0.124 |

% Volume Expansion, 3 Days at 54 °C

| | | | | | | | | |
|---|---|---|---|---|---|---|---|---|
| 140 °C/25 min. | 1930 | 102 | 1655 | 103 | 2075 | 99 | 1995 | 100 |
| 190 °C/30 min. | 2531 | 102 | 2084 | 96 | 2454 | 103 | 2421 | 108 |

| | | |
|---|---|---|
| Ex. I-12 | Ex. I-13 | Ex. I-14 |

| | | | | | |
|---|---|---|---|---|---|
| % Exp | % Ret | % Exp | % Ret | % Exp | % Ret |

% Volume Expansion, Initial

| | | | | | | |
|---|---|---|---|---|---|---|
| 140 °C/25 min. | 2042 | NA | 1852 | NA | 2054 | NA |
| 190 °C/30 min. | 2340 | NA | 2425 | NA | 2455 | NA |

% Volume Expansion, 3 Days at 35 °C/85% R.H.

| | | | | | | |
|---|---|---|---|---|---|---|
| 140 °C/25 min. | 2054 | 101 | 2064 | 111 | 1995 | 97 |
| 190 °C/30 min. | 2547 | 109 | 2511 | 104 | 2404 | 98 |

| | | | |
|---|---|---|---|
| Moisture Content (%) | 0.134 | 0.110 | 0.086 |

% Volume Expansion, 3 Days at 54 °C

| | | | | | | |
|---|---|---|---|---|---|---|
| 140 °C/25 min. | 2005 | 98 | 2077 | 112 | 2031 | 99 |
| 190 °C/30 min. | 2442 | 104 | 2460 | 101 | 2425 | 99 |

Table 7A sets forth Inventive Examples I-15 through I-16, containing zinc oxide. Ex. I-15 is free from zinc neodecanoate whereas Ex. I-16 includes zinc neodecanoate (liquid zinc salt). The formulations were heated to expand the material initially after compounding and after 3 days storage at 35 °C and 95% relative humidity. Heating was conducted at about 135 °C, 140 °C, and 190 °C. Table 7B summarizes the test results. The addition of zinc neodecanoate decreases the difference in foaming percentage between the highest and lowest temperature used for foaming from 770 percentage points without zinc neodecanoate to 401 percentage points with zinc neodecanoate. A formulation with zinc neodecanoate may find application in adhesives and tapes.

TABLE 7A

| Ingredients | Ex. I-15 | Ex. I-16 |
|---|---|---|
| EnBA | 28.68 | 28.68 |
| EVA | 22.16 | 22.16 |
| EnBA-GMA | 5.00 | 5.00 |
| Hydrocarbon Resin | 14.66 | 14.66 |
| Antioxidant | 0.50 | 0.50 |
| Peroxide-40 | 1.05 | 1.05 |
| BPO-75 | 0.36 | 0.36 |
| Zinc Oxide | 15.84 | 14.62 |
| Zn NDA | — | 1.22 |
| Dicyandiamide 1 | 1.00 | 1.00 |
| Oleamide | 0.80 | 0.80 |
| Pigment | 0.10 | 0.10 |
| ADCA | 9.50 | 9.50 |
| DPHA | 0.35 | 0.35 |
| TOTAL | 100.00 | 100.00 |

TABLE 7B

| | |
|---|---|
| Ex. I-15 | Ex. I-16 |

| | | | |
|---|---|---|---|
| % Exp | % Ret | % Exp | % Ret |

% Volume Expansion, Initial

| | | | | |
|---|---|---|---|---|
| 135 °C/25 min. | 1799 | NA | 1917 | NA |
| 140 °C/15 min. | 1637 | NA | 1911 | NA |
| 140 °C/25 min. | 2121 | NA | 2095 | NA |
| 190 °C/30 min. | 2569 | NA | 2318 | NA |

% Volume Expansion, 3 Days at 35 °C/85% R.H.

| | | | | |
|---|---|---|---|---|
| 140 °C/25 min. | 1982 | −6.6 | 2068 | −1.3 |
| 190 °C/30 min. | 2561 | −0.3 | 2470 | 6.6 |

Table 8A sets forth Inventive Examples I-17 through I-19, containing Zinc neodecanoate, and suitable for adhesive and tape formulations. The formulations were heated to expand the material initially after compounding. Volumetric expansion was conducted at 140 °C and 163 °C. Table 8B summarizes the test results. Low-temperature bake differences are realized in the Comparative Example C-5, without the Zinc neodecanoate and dicyanamide

TABLE 8A

| | Ex. C-5 | Ex. I-19 | Ex. I-18 | Ex. I-17 |
|---|---|---|---|---|
| EnBA | 5.02 | 5.02 | 5.02 | 5.02 |
| EnBA-GMA | 2.01 | 2.01 | 2.01 | 2.01 |
| EPDM | 5.02 | 5.02 | 5.02 | 5.02 |
| EPDM-L | 2.01 | 2.01 | 2.01 | 2.01 |
| PIB | 6.00 | 8.00 | 6.00 | 6.00 |
| CI Resin | 4.60 | 4.60 | 4.60 | 4.60 |
| Process Oil | 12.60 | 13.28 | 10.60 | 5.60 |
| Bromobutyl Rubber | 6.03 | 6.03 | 6.03 | 6.03 |
| Peroxide-40 | 1.50 | 1.50 | 1.50 | 1.50 |
| BPO-75 | — | — | — | 0.10 |
| Aramid Pulp | 0.07 | 0.07 | 0.07 | 0.07 |
| Zinc Oxide | 4.00 | 3.00 | 4.00 | 4.00 |
| Zn NDA | — | 2.00 | 2.00 | 2.00 |
| Dicycanamide 1 | — | 1.00 | 1.00 | 1.00 |
| Carbon black | 0.30 | 0.30 | 0.30 | 0.30 |
| ADCA | 5.30 | 5.30 | 5.30 | 5.30 |
| Limestone 325 Mesh | 28.04 | 27.91 | 27.04 | 26.94 |
| Epoxidized Dimer Acid | 5.00 | — | 5.00 | 10.00 |
| C5/C9 Resin | 10.70 | 10.00 | 10.70 | 10.70 |
| Antioxidant | 1.00 | 1.00 | 1.00 | 1.00 |
| TMPTMA | 0.80 | 0.45 | 0.80 | 0.80 |
| PBD MA-Grafted | — | 1.50 | — | — |
| Total | 100.00 | 100.00 | 100.00 | 100.00 |

TABLE 8B

| | | | |
|---|---|---|---|
| Ex. C-5 | Ex. I-19 | Ex. I-18 | Ex. I-17 |
| % Exp | % Exp | % Exp | % Exp |

% Volume Expansion, Initial

| | | | | |
|---|---|---|---|---|
| 140 °C/25 min. | 13 | 1109 | 1215 | 1027 |
| 163 °C/30 min. | 1218 | 1327 | 1336 | 1093 |

Table 9A sets forth additional examples of tacky expandable sealants, I-20 and I-21, made according to the invention. The examples contain dicyandiamide, zinc neodecanoate, a high level of zinc oxide as a conductive filler and a small amount of coated urea. It should be noted that the level of zinc oxide in the inventive examples is much higher than typically used in activation of azodicarbonamide. Table 9B summarizes the results relative to comparative Example C-6 which is a commercial tacky sealant material available from L&L Products, Inc. It should be noted that the comparative material contains only 0.2% dicyandiamide, 2% zinc oxide, no coated urea, and no zinc neodecanoate. Ex. I-20 exhibits a general consistency of expansion across high and low temperature bakes, which can be desirable.

TABLE 9A

| | Ex. C-6 | Ex. I-20 | Ex. I-21 |
|---|---|---|---|
| L-2664 Commercially Available | 100.00 | | |
| Tacky Sealant, 1000% expanding | | | |
| EnBA | | 2.00 | 2.00 |
| EVA-2 | | 1.00 | 1.00 |
| EPDM | | 5.00 | 5.00 |
| EPDM-2 | | 2.00 | 2.00 |
| EPDM-L | | 2.50 | 2.50 |
| EEA-MA | | 5.00 | 5.00 |
| PIB-2 | | 9.00 | 9.00 |
| CI Resin | | 4.60 | 4.60 |
| C5/C9 Resin | | 9.70 | 9.70 |
| Process Oil | | 15.00 | 15.00 |
| Bromobutyl Rubber | | 3.00 | 3.00 |
| Aramid Pulp | | 0.10 | 0.10 |
| Zinc Oxide | | 10.00 | 10.00 |
| Zn NDA | | 2.00 | 2.00 |
| Dicycanamide 1 | | 3.00 | 3.00 |
| Carbon black | | 0.30 | 0.30 |
| Coated Urea | | 0.05 | 0.05 |
| ADCA | | 5.80 | 5.80 |
| Limestone 325 Mesh | | 18.45 | 17.45 |
| Antioxidant | | — | 1.00 |
| Peroxide-40 | | 0.90 | 0.90 |
| DPHA | | 0.60 | 0.60 |
| Total | 100.00 | 100.00 | 100.00 |

TABLE 9B

| | | |
|---|---|---|
| Ex. C-6 | Ex. I-20 | Ex. I-21 |
| % Exp | % Exp | % Exp |

% Volume Expansion, Initial

| | | | |
|---|---|---|---|
| 140 °C/25 min. | 52 | 1164 | 845 |
| 163 °C/30 min. | 1423 | 1316 | 1205 |
| 190 °C/30 min. | 1548 | 1197 | 779 |

It is understood that the above description is intended to be illustrative and not restrictive. Accordingly, the specific embodiments of the present invention as set forth are not intended as being exhaustive or limiting of the teachings. Many embodiments as well as many applications besides the examples provided will be apparent to those of skill in the art upon reading the above description.

The scope of the invention should, therefore, be determined not with reference to the above description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements can be provided by a single integrated element. Alternatively, a single element might be divided into separate plural elements. The disclosure of “a” or “one” to describe an element is not intended to foreclose additional elements.

While the terms first, second, third, etc., may be used herein to describe various components, these components should not be limited by these terms. These terms may be used to distinguish one component from another component. Terms such as “first,” “second,” and other numerical terms when used herein do not imply a sequence or order unless clearly indicated by the context. Thus, a first component discussed herein could be termed a second component without departing from the teachings.

The terms “generally,” “substantially,” or “about” to describe measurements, percentages, or ratios may mean±/−10% or less, +/−5% or less, or even +/−1% or less. The terms “generally,” “substantially,” or “about” to describe measurements, percentages, or ratios may mean±/−0.01% or greater, +/−0.1% or greater, or even +/−0.5% or greater.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time, and the like is, for example, from 1 to 90, from 20 to 80, or from 30 to 70, it is intended that intermediate range values such as (for example, 15 to 85, 22 to 68, 43 to 51, etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. Unless otherwise stated, all ranges include both endpoints and all numbers between the endpoints.

As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

The disclosures of all articles and references, including patent applications and publications, are incorporated by reference for all purposes.

What is claimed is:

1. A foamable sealant material comprising:
one or more polymeric materials,
azodicarbonamide as a foaming agent,
a water insoluble urea or guanidine derivative, and
a zinc carboxylate salt;
wherein the water insoluble urea or guanidine derivative and the zinc carboxylate salt cooperate to reduce an activation temperature of the azodicarbonamide.

2. The foamable sealant material according to claim 1, wherein the activation temperature of the azodicarbonamide is reduced to about 160 °C or less.

3. The foamable sealant material according to claim 2, further defined by one or more of the following: wherein the water insoluble urea or guanidine derivative is dicyandiamide; and wherein the water insoluble urea or guanidine derivative is present in an amount of about 0.5% to about 5% of the foamable sealant material, by weight.

4. (canceled)

5. The foamable sealant material according to claim 3, wherein the zinc carboxylate salt is; a polymeric zinc ionomer; or selected from one or more zinc salts of a long chain carboxylic acid, zinc stearate, zinc laurate, zinc caprylate, zinc neodecanoate, zinc 2-ethylhexanoate, and zinc octoate, or any combination thereof; and wherein the zinc carboxylate salt is present in an amount of about 0.5% to about 5% of the foamable sealant material, by weight.

6. (canceled)

7. (canceled)

8. The foamable sealant material according to claim 3, wherein the zinc carboxylate salt is one or more zinc salts of long chain carboxylic acids having a carbon chain length of C6 to C18; optionally wherein the long chain carboxylic acids comprise a mixture of saturated and unsaturated carboxylic acids; and wherein the zinc carboxylate salt is present in an amount of about 0.5% to about 5% of the foamable sealant material, by weight.

9. (canceled)

10. (canceled)

11. The foamable sealant material according to claim 3, wherein the one or more polymeric materials include one or more elastomers, thermoplastic elastomers, thermoplastic polymers, or any combination thereof; wherein the one or more elastomers include ethylene propylene rubber, ethylene propylene diene monomer rubber, styrene butadiene rubber, nitrile rubber, polybutadiene rubber, natural rubber, isobutylene-isoprene rubber, or any combination thereof; wherein the one or more thermoplastic elastomers include one or more block copolymers of styrene with butadiene or isoprene; and wherein the one or more polymeric materials are present in an amount of about 40% to about 70% of the foamable sealant material, by weight.

12. (canceled)

13. (canceled)

14. The foamable sealant material according to claim 3, wherein the one or more polymeric materials include one or more thermoplastic polymers; and wherein the one or more thermoplastic polymers are selected from a copolymer and/or a terpolymer of ethylene.

15. The foamable sealant material according to claim 3, wherein the one or more polymeric materials include one or more thermoplastic polymers; and wherein the one or more thermoplastic polymers are selected from: ethylene, polyethylene, ethylene octene, ethylene hexene, ethylene butene, n-butyl acrylate copolymer, ethylene vinyl acetate copolymer, ethylene n-butyl acrylate GMA terpolymer, or any combination thereof.

16. The foamable sealant material according to claim 3, wherein the foamable sealant material further comprises a thermally conductive filler characterized by one or more of the following features: wherein the thermally conductive filler includes iron powder, aluminum powder, zinc powder, aluminum nitride, aluminum oxide, zinc oxide, graphite, graphene, iron phosphide, strontium ferrite, graphitic boron nitride, silicon carbide, or any combination thereof; and wherein the thermally conductive filler is present in an amount of about 5% to 30% of the foamable sealant material, by weight.

17. (canceled)

18. (canceled)

19. (canceled)

20. (canceled)

21. The foamable sealant material according to claim 3, further defined by one or more of the following: wherein the azodicarbonamide is present in an amount of about 2% to about 15% of the foamable sealant material, by weight; and wherein the azodicarbonamide has a particle size distribution of about 1 micron to about 20 microns, as determined by ASTM UOP856-07.

22. (canceled)

23. The foamable sealant material according to claim 1, further defined by one or more of the following features: wherein the foamable sealant material is heat-activated to foam and/or cross-link; wherein a volume of the foamable sealant material increases by about 150% to about 2,200%; and wherein the foamable sealant material fully foams and/or cross-links at about 25 minutes or less.

24. (canceled)

25. (canceled)

26. The foamable sealant material according to claim 23, wherein the volume of the foamable sealant material increases 1,800% or more when heated to 140 °C for 25 minutes.

27. The foamable sealant material according to claim 8, wherein the foamable sealant material is free of a dispersing agent.

28. (canceled)

29. The foamable sealant material according to claim 16, wherein the foamable sealant material further comprises an antioxidant defined by one or more of the following features: wherein the antioxidant is derived from one or more sterically hindered phenols; wherein the antioxidant is present in an amount of about 0.1% to 2.5% of the foamable sealant material, by weight; and wherein the antioxidant is present with the thermally conductive filler.

30. (canceled)

31. (canceled)

32. (canceled)

33. The foamable sealant material according to claim 1, wherein the foamable sealant material further comprises zinc oxide to reduce the activation temperature of azodicarbonamide; and wherein the zinc oxide is present in an amount of about 1% to 15% of the foamable sealant material, by weight.

34. (canceled)

35. The foamable sealant material according to claim 1, wherein the foamable sealant material further comprises one or more cross-linking agents; and wherein the one or more cross-linking agents include 1,1-di(tert-butylperoxy)-3,3,5-trimethylcyclohexane, dibenzoyl peroxide, benzoyl peroxide, methyl ethyl ketone peroxide, peroxydicarbonate, tertiary-butyl peroxy 2-ethyl hexanoate, tertbutyl hydroperoxide, tertbutyl peracetate, tertbutyl perbenzoate, benzoyl peroxide, tert-amyl peroxybenzoate, tert-amyl peroxy-2-ethyl hexanoate, 2,4-pentanedione peroxide, cumyl hydroperoxides, cumene hydroperoxide, dicumene peroxide, or any combination thereof.

36. (canceled)

37. The foamable sealant material according to claim 35, wherein the foamable sealant material further comprises one or more cross-linking coagents, one or more hydrocarbon resins, carbon black, oleamide, or any combination thereof.

38. A method for producing a foamable sealant material, the method comprising: pre-compounding a zinc carboxylate salt with a portion of one or more polymeric materials; and compounding the pre-compound with a remaining portion of the one or more polymeric materials with azodicarbonamide and a water insoluble urea or guanidine derivative.

39. The method according to claim 38, further comprising heating the foamable sealant material to about 160 °C or less for about 25 minutes or less.

40. (canceled)

41. The method according to claim 39, further comprising causing the foamable sealant material to increase in volume by about 150% to about 2,200%.
